(19) United States
(12) Patent Application Publication
(10) Pub. No.: US 2017/0028321 A1
(43) Pub. Date: Feb. 2, 2017

(54) Bellows, Filter Element, and Method

(71) Applicant: MANN+HUMMEL GMBH, Ludwigsburg (DE)

(72) Inventor: Klaus Gehwolf, Mamming (DE)

(21) Appl. No.: 15/223,273

(22) Filed: Jul. 29, 2016

(30) Foreign Application Priority Data
Jul. 29, 2015 (DE) 10 2015 009 625.7

(51) Int. Cl. B01D 29/21; B01D 29/11

(52) U.S. Cl. CPC B01D 29/213; B01D 29/111; B01D 2201/12; B01D 2201/291

(57) ABSTRACT

A bellows for a filter element is provided with a flat filter medium that has a first end section and a second end section opposite the first end section. A vulcanizable adhesive material adhesively connects the first end section and the second end section to each other. In a method for producing such a bellows, a vulcanizable adhesive material is supplied and the first and second end sections of the filter medium are connected to each other by vulcanizing the adhesive material.

### BACKGROUND OF THE INVENTION

The present invention concerns a bellows for a filter element, a filter element with such a bellows, and a method for producing such a bellows.

Filter elements, for example, oil filter elements, comprise a star-shaped folded endless bellows that is arranged between two end disks. In order to form such an endless bellows, a first end section of a filter medium and a second end section of the filter medium are connected with each other.

DE 10 2011 011 771 A1 describes a method for producing a filter element. In this context, two end sections of a flat filter medium are connected to each other by a plastic material in that solid, in particular thread-shaped, synthetic material is plastified between the end sections that are placed on each other.

### SUMMARY OF THE INVENTION

Based on this background, the present invention has the object to provide an improved bellows for a filter element.

Accordingly, a bellows for a filter element is proposed that comprises a flat filter medium, wherein a first end section of the filter medium is adhesively connected by means of a vulcanizable adhesive material with a second end section of the filter medium.

In contrast to a thermoplastic synthetic material, the vulcanizable adhesive material has elastomeric properties. Accordingly, the bellows is deformable to a great extent without the adhesive connection of the end sections being damaged. In particular, the vulcanizable adhesive material is particularly resistant against fluids such as fuel or oil. In comparison to a connection with polyurethane material, the vulcanizable adhesive material has a significantly higher viscosity so that a mold for application of the adhesive material to the end sections is not mandatorily required. In particular, the adhesive material reacts chemically when heated so that it is crosslinked, swells, and/or foams. The bellows can also be referred to as an endless bellows.

In embodiments, the adhesive material comprises rubber. The adhesive material may comprise natural and/or synthetic rubber. Moreover, the adhesive material may comprise sulfur or sulfur-donating substances, such as disulfur dichloride, and may further comprise fillers as well as catalysts for increasing the reaction rate.

In further embodiments, the adhesive material is foamable and/or expandable by exposure to heat. In this way, the adhesive material penetrates also into small cavities or gaps so that a particularly good connection and sealing action of the end sections of the filter medium is achieved.

In further embodiments, the filter medium is of a multi-layer configuration wherein the adhesive material connects individual layers of the filter medium with each other at the end sections. In particular, the adhesive material is designed to seal cut edges of the multi-layer filter medium. In this way, not only a permanent connection of the end sections with each other is achieved but also a sealing action of the cut edges is obtained.

In further embodiments, the filter medium is folded wherein respective terminal folds of the filter medium form the end sections. The filter medium is in particular arranged such that the bellows is star-shaped. In particular, the filter medium forms a closed ring. Alternatively, the filter medium may not be folded and is thus flat.

In further embodiments, the adhesive material is designed to impregnate the filter medium. In this way, the adhesive material penetrates into the filter medium so that the end sections are fluid-tightly sealed and connected to each other.

Moreover, a filter element with such a bellows is proposed. The filter element comprises preferably a first end disk and a second end disk wherein the bellows is arranged between the end disks. The filter medium is used preferably in motor vehicles, trucks, construction vehicles, watercraft, railway vehicles, agricultural machines or vehicles, or aircraft. The filter element can be designed to filter water, air, urea solution, oil or fuel, such as diesel fuel, kerosene or gasoline. The filter element can be, for example, an oil filter, a fuel filter or the like.

Moreover, a method for producing a bellows is proposed. The method comprises the following method steps: providing a flat filter medium; supplying a vulcanizable adhesive material; and adhesively connecting a first end section of the filter medium with a second end section of the filter medium by means of the adhesive material, wherein the adhesive material is vulcanized. The adhesive material is heated for vulcanizing it. For this purpose, heating jaws can be provided, for example. Preferably, the heated adhesive material is of high viscosity so that it does not run.

In embodiments, the adhesive material is extruded during or prior to supplying the same. The adhesive material can be flat, of a multi-layer configuration, or rolled. In particular, the adhesive material can be extruded to any cross-sectional geometry. For example, the adhesive material can have an E-shaped, T-shaped or W-shaped cross-sectional geometry.

In further embodiments, the adhesive material is vulcanized in a mold. Preferably, the adhesive material and at least partially the end sections are placed into the mold. By heating the mold, the adhesive material is boiled and expanded and/or foamed so that it fluid-tightly and permanently connects the end sections with each other.

Further possible implementations of the invention comprise also combinations, not explicitly mentioned, of features or method steps described above or in the following with regard to the embodiments. In this context, a person of skill in the art will also add individual aspects as improvements or supplements to the respective basic form of the invention.

### BRIEF DESCRIPTION OF THE DRAWINGS

Further embodiments of the invention are subject matter of the dependent claims as well as of the embodiments of the invention described in the following. Moreover, the invention will be explained in more detail with the aid of embodiments with reference to the accompanying Figures.

FIG. 1 shows a schematic perspective partial section view of an embodiment of a filter element.

FIG. 2 shows a schematic plan view of an embodiment of a bellows for the filter element according to FIG. 1.

FIG. 3 is an enlarged detail view of the bellows according to FIG. 2 according to the detail III of FIG. 2.

FIG. 4 is a schematic plan view of an embodiment of an adhesive material for the bellows according to FIG. 2.

FIG. 5 is a schematic plan view of an embodiment of a mold for processing the adhesive material according to FIG. 4.

FIG. 6 is a schematic perspective view of a further embodiment of an adhesive material for the bellows according to FIG. 2.

FIG. 7 is a schematic perspective view of a further embodiment of an adhesive material for the bellows according to FIG. 2.

FIG. 8 is a schematic block diagram representation of a method for producing a bellows.

In the Figures, same or functionally the same elements, if not indicated otherwise, are provided with the same reference characters.

### DESCRIPTION OF PREFERRED EMBODIMENTS

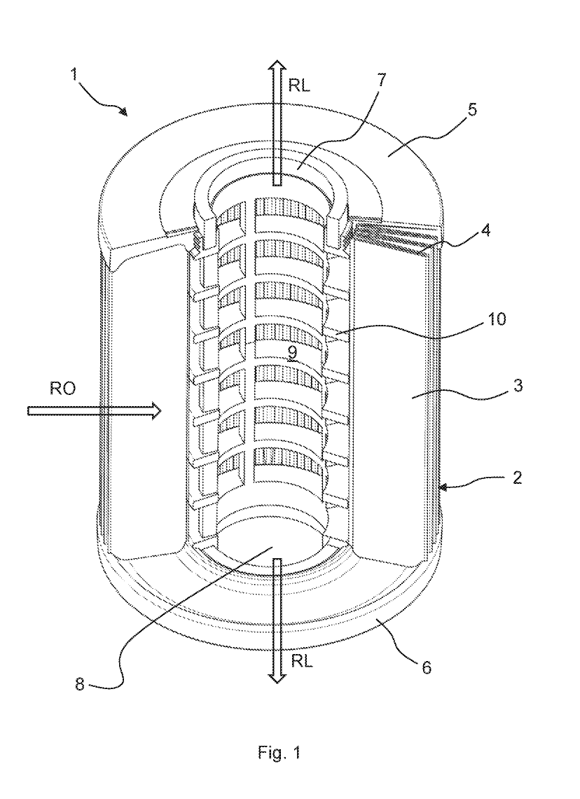

FIG. 1 shows a schematic perspective partial section view of an embodiment of a filter element 1. The filter element 1 can be suitable to filter water, air, urea solution, oil or fuel, such as diesel fuel, kerosene or gasoline. In particular, the filter element 1 is used in motor vehicles, trucks, construction vehicles, watercraft, railway vehicles or aircraft. Moreover, the filter element 1 can also be used in buildings. For example, the filter element 1 can be an air filter, oil filter, fuel filter or the like.

The filter element 1 comprises a bellows 2, in particular an endless bellows. The bellows 2 is made of a filter medium 3. In particular, the filter medium 3 is configured as a fold pack of pleated filter material. Frequently, synthetic nonwoven materials, folded in a zigzag shape, are used as filter materials. The filter medium 3 comprises, for example, a filter fabric, laid filter material, or a filter nonwoven. In particular, the filter medium 3 can be produced by a spunbonding or meltblowing method. Moreover, the filter medium 3 can be felted or needled. The filter medium 3 may comprise natural fibers, such as cellulose or cotton, or synthetic fibers, for example, of polyester, polyvinylsulfite, or polytetrafluoroethylene. Fibers of the filter medium 3 can be oriented during processing slantedly and/or transversely relative to the machine direction.

At the top side and bottom side in the orientation of FIG. 1, an end disk 5, 6 is provided at a respective end of the filter medium 3 on fold profiles 4 of the folded filter medium 3 which forms the bellows 2. The filter element 1 comprises at least one end disk 5, 6, preferably however two end disks 5, 6. In particular, the end disks 5, 6 are connected fluid-tightly with the filter medium 3. In this context, an adhesive connection of the end disks 5, 6 with the filter medium 3 can be realized, for example, with an adhesive film which is facing the filter medium 3. By means of the end disks 5, 6, the filter element 1 is imparted with a certain stability and can be used in an appropriate fluid circuit. The filter medium 3 can also be pressed into partially melted material of the end disks 5, 6. A connecting opening 7 is a part of the upper end disk 5, for example. In analogy thereto, the lower end disk 6 can also be provided with a connecting opening 8 which, like the connecting opening 7 of the upper end disk 5, is connectable to an operating medium connector.

In the orientation of FIG. 1, fold profiles 4 of the bellows 2 are shown at the top side. In operation, for example, as an oil filter, the fluid to be filtered, for example, oil, flows through the filter surface area that is enlarged by the pleated filter medium 3. In general, the filter materials and geometries of the filter medium 3 or of the filter element 1 are matched to a predetermined flow direction. For example, in FIG. 1, laterally the raw fluid RO and in upward and downward directions the filtered clean fluid RL are illustrated. Accordingly, in the orientation of FIG. 1, a surface of the bellows 2 which is facing the interior 9 of the filter element 1 is the outflow side and the outer wall surface of the cylindrical bellows 2 is the inflow side of the filter element 1. Inside the bellows 2, an optional support element 10, in particular a support pipe, is provided which is positioned between the end disks 5, 6. The support element 10 can be connected with the end disks 5, 6.

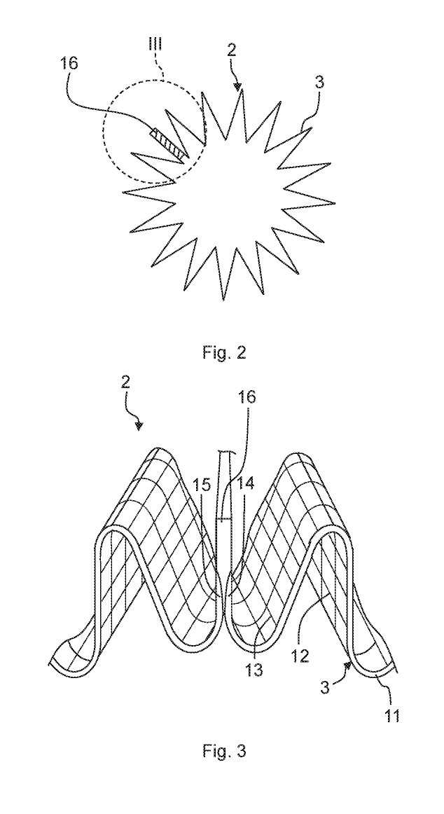

FIG. 2 shows a schematic view of an embodiment of the bellows 2. As shown in FIG. 2, the bellows 2 is star-shaped and of a closed ring configuration. The bellows 2 is therefore an endless bellows.

FIG. 3 shows an enlarged perspective detail of FIG. 2 according to the area III circled in FIG. 2. In the following, reference is being had simultaneously to FIGS. 2 and 3.

The filter medium 3 may comprise a filter layer 11 as well as support structures 12, 13 arranged on either side of the filter layer 11. The support structures 12, 13 can be of a grid shape. The filter medium 3 comprises a first end section 14 and a second end section 15. For forming the bellows 2, the first end section 14 of the filter medium 3 is adhesively connected with the second end section 15 by means of a vulcanizable adhesive material 16. The adhesive material 16 comprises preferably synthetic and/or natural rubber. The adhesive material 16 can moreover comprise sulfur or sulfur-donating substances, such as disulfide dichloride, and catalysts. The adhesive material 16 can be present, for example, in a flat, multi-layer, extruded or rolled form. In particular, the adhesive material 16 is foamable and/or expandable by exposure to heat.

Preferably, the adhesive material 16 is designed to impregnate the filter medium 3. When heated, the adhesive material 16 reacts chemically so that it expands and penetrates into the filter medium 3. Accordingly, the end sections 14, 15 of the filter medium are sealed as well as fluid-tightly connected with each other. As shown in FIG. 3, folds, in particular terminal folds, form the end sections 14, 15 of the filter medium 3, respectively.

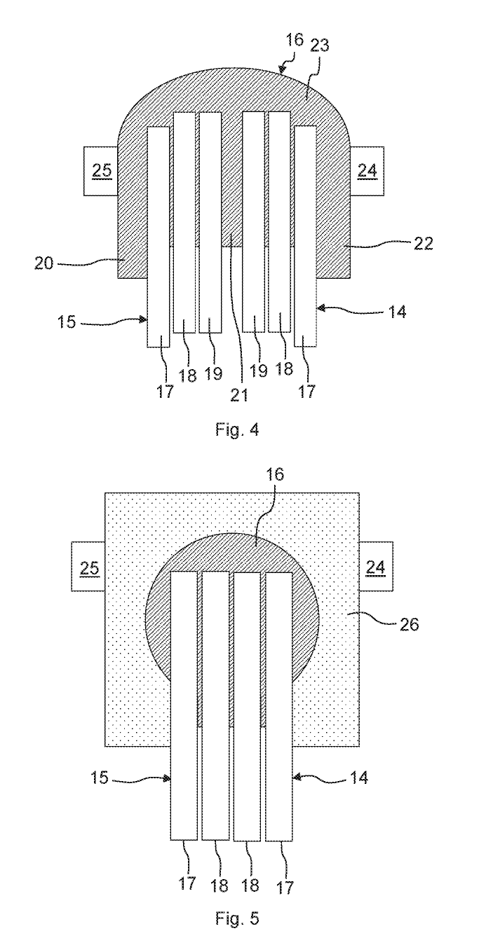

FIG. 4 shows that the filter medium 3 and in particular the end sections 14, 15 may have several layers 17 to 19. The adhesive material 16 can be extruded, for example, and in cross-section can have an E-shaped geometry with three webs 20 to 22 which extend away from a base section 23. The end sections 14, 15 are arranged between the webs 20 to 22 and the adhesive material 16 can be heated, for example, by means of heating jaws 24, 25. By being heated, the adhesive material 16 reacts chemically, in particular it is vulcanized, wherein the adhesive material 16 penetrates in and between the individual layers 17 to 19 of the end sections 14, 15 and connects them to each other fluid-tightly.

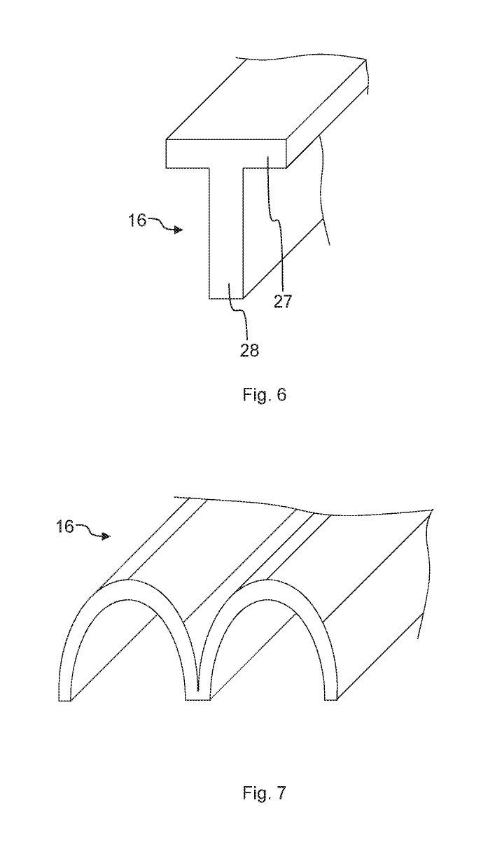

FIG. 5 shows a mold 26 for heating the adhesive material 16. The adhesive material 16 is placed into the mold 26 wherein the end sections 14, 15 at least partially are also arranged in the mold 26. By heating the mold 26, the adhesive material 16 boils and impregnates as well as envelopes the end sections 14, 15 so that they are connected fluid-tightly to each other. Heating jaws 24, 25 can be arranged on the exterior side of the mold 26. Alternatively, the heating jaws 24, 25 can be integrated into the mold 26.

FIG. 6 shows an embodiment of an adhesive material 16 in an extruded form wherein the adhesive material 16 has a T-shaped geometry with a horizontally extending short web 27 and a vertically extending long web 28. The cross-sectional geometry of the adhesive material 16 is completely arbitrary and can be matched to the end sections 14, 15 to be connected or to the number of layers 17 to 19 of the end sections 14, 15 to be connected to each other.

FIG. 7 shows a further embodiment of an extruded adhesive material 16. The extruded adhesive material 16 comprises, for example, an M shape or upside down W shape. The end sections 14, 15 can be arranged between the legs of the M shape or upside down W shape.

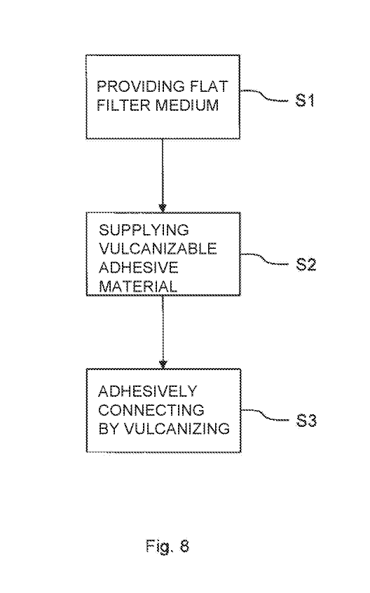

FIG. 8 shows schematically a block diagram of a method for producing such a bellows 2. In step S1, the flat filter medium 3 is provided. In this context, it may be folded in a zigzag shape. In step S2, the vulcanizable adhesive material 16 is supplied. During or prior to supplying the adhesive material 16, the latter can be extruded into a desired shape.

In step S3, the first end section 14 of the filter medium 3 is adhesively connected with the second end section 15 of the filter medium 3 by means of the adhesive material 16 wherein the adhesive material 16 is vulcanized. In particular, the adhesive material 16 can be vulcanized in the mold 26. Vulcanization causes the adhesive material 16 to foam and/or expand. In particular, vulcanization causes the adhesive material 16 to penetrate into the end sections 14, 15 of the filter medium 3 and thereby connect them fluid-tightly.

The adhesive material 16 that can also be referred to as adhesive film is resistant relative to fluids such as fuel or oil. Moreover, the adhesive material 16, due to its swelling behavior, penetrates well into the filter medium 3 and connects the end sections 14, 15 of the filter medium 3 reliably with each other. Moreover, cut edges of multi-layer filter media 3 can be reliably and fluid-tightly framed.

While specific embodiments of the invention have been shown and described in detail to illustrate the inventive principles, it will be understood that the invention may be embodied otherwise without departing from such principles.

What is claimed is:

1. A bellows for a filter element, the bellows comprising:
a flat filter medium comprising a first end section and a second end section opposite the first end section;
a vulcanizable adhesive material adhesively connecting the first end section and the second end section to each other.

2. The bellows according to claim 1, wherein the adhesive material comprises rubber.

3. The bellows according to claim 1, wherein the adhesive material is foamable by exposure to heat.

4. The bellows according to claim 1, wherein the adhesive material is expandable by exposure to heat.

5. The bellows according to claim 1, wherein the adhesive material is foamable and expandable by exposure to heat.

6. The bellows according to claim 1, wherein the filter medium is of a multi-layer configuration comprising individual layers and wherein the adhesive material connects the individual layers of the filter medium at the first end section and the second end section with each other.

7. The bellows according to claim 1, wherein the filter medium is folded and comprises terminal folds, wherein the terminal folds form the first and second end sections, respectively.

8. The bellows according to claim 1, wherein the adhesive material is configured to impregnate the filter medium.

9. A filter element comprising a bellows according to claim 1.

10. A method for producing a bellows, the method comprising:
providing a flat filter medium;
supplying a vulcanizable adhesive material;
adhesively connecting a first end section of the filter medium and a second end section of the filter medium to each other by vulcanizing the adhesive material.

11. The method according to claim 10, comprising extruding the adhesive material prior to the step of supplying.

12. The method according to claim 10, comprising extruding the adhesive material in the step of supplying.

13. The method according to claim 10, comprising vulcanizing the adhesive material in a mold.
